(19) United States
(12) Patent Application Publication
(10) Pub. No.: US 2025/0270862 A1
(43) Pub. Date: Aug. 28, 2025

(54) DOOR LOCK DEVICE FOR VEHICLE

(71) Applicants: AISIN CORPORATION, Kariya-shi (JP); AISIN (SUZHOU) TECHNICAL CENTER CO., LTD., Suzhou (CN)

(72) Inventors: Guodong GAO, Suzhou (CN); Yangyang Zhu, Suzhou (CN); Senri Kawaguchi, Kariya-shi (JP); Satoshi Kikusawa, Kariya-shi (JP)

(73) Assignees: AISIN CORPORATION, Kariya-shi (JP); AISIN (SUZHOU) TECHNICAL CENTER CO., LTD., Suzhou (CN)

(21) Appl. No.: 18/958,858

(22) Filed: Nov. 25, 2024

(30) Foreign Application Priority Data
Feb. 28, 2024 (CN) 202420376047.7

(51) Int. Cl. E05B 85/24; E05B 77/38

(52) U.S. Cl. CPC E05B 85/243; E05B 77/38

(57) ABSTRACT

A door lock device for a vehicle capable of reducing the sound produced when a vehicle door is unlocked includes: a base component, where the base component is fixed to a vehicle door for opening and closing an opening of a vehicle body; a striker, where the striker is fixed to an edge of the opening on the vehicle body; and a latch, where the latch is arranged on the base component and has a latch groove capable of being engaged with and disengaged from the striker, and the latch is capable of rotating between a locking position in which the striker is constrained by the latch groove and an unlocking position in which the striker is released, wherein a protrusion part protruding toward an inner side of the latch groove is provided on a surface of the latch groove that contacts the striker when the latch rotates.

### FIELD OF THE DISCLOSURE

The disclosure relates to a door lock device for a vehicle.

### BACKGROUND

In vehicles, a sealing strip is generally provided around an opening of the vehicle body to perform sealing between the vehicle door and the opening. When a door lock device is controlled to be unlocked, the vehicle door may be sprung open in an opening direction due to the restoring force of the squeezed sealing strip. When the load of the vehicle door being sprung open is large, the fitting part between the striker fixed to the vehicle body and the latch provided on the vehicle door becomes more skewed, and when the force is released, the door lock device makes a loud noise, causing discomfort to the passengers.

### SUMMARY

An objective of the disclosure is to provide a door lock device for a vehicle that can reduce the noise when a vehicle door is unlocked.

In order to achieve the objective, a door lock device for a vehicle of an embodiment of the disclosure includes: a base component, where the base component is fixed to a vehicle door for opening and closing an opening of a vehicle body; a striker, where the striker is fixed to an edge of the opening on the vehicle body; and a latch, where the latch is provided on the base component and has a latch groove capable of being engaged with and disengaged from the striker, and the latch is capable of rotating between a locking position in which the striker is constrained by the latch groove and an unlocking position in which the striker is released, wherein a protrusion part protruding toward an inner side of the latch groove is provided on a surface of the latch groove that contacts the striker when the latch rotates.

According to such a structure, when the vehicle door is sprung open during unlocking, the striker is disengaged from the latch groove along the protrusion part, and the amount of interference of the latch groove on the striker during the disengagement of the striker can be increased. In this way, compared with a case in which no protrusion part is provided, the speed at which the striker is disengaged can be slowed down, and the speed at which the vehicle door is sprung open can be reduced. As a result, the noise during unlocking can be effectively reduced.

In the door lock device for a vehicle of the disclosure, preferably, the protrusion amount of the protrusion part gradually increases and then gradually decreases toward a disengaging direction in which the striker is disengaged from the latch groove.

According to such a structure, not only the speed at which the striker is disengaged can be slowed down, and but also the disengagement of the striker is not hindered, so that the striker can be smoothly disengaged from the latch groove.

In the door lock device for a vehicle of the disclosure, preferably, the protrusion part is formed in an arc shape when viewed along a rotation axis direction of the latch.

According to such a structure, the striker can be moved smoothly to prevent the vehicle door from being stuck when the vehicle door is opened.

In the door lock device for a vehicle of the disclosure, preferably, the protrusion part is a resin part covering the latch.

According to such a structure, the protrusion part can be formed in a simple manner. In addition, because the protrusion part is made of resin, the noise when the striker moves in the latch groove can be further reduced.

In the door lock device for a vehicle of the disclosure, preferably, the latch is provided with an abutting part, and the base component is provided with an abutted part. Further rotation of the latch when the latch is rotated to the unlocking position is restricted by the abutment between the abutting part and the abutted part. The abutted part is made of a material different from that of the base component.

According to such a structure, the abutted part made of a material different from that of the base component abuts against the abutting part, so that the noise for positioning the latch during unlocking can be reduced. Therefore, the noise during unlocking can be further reduced.

In the door lock device for a vehicle of the disclosure, preferably, the abutted part is a rubber stopper.

According to such a structure, the noise during unlocking can be further reduced.

In the door lock device for a vehicle of the disclosure, preferably, the base component is provided with a base groove for the striker to pass through.

According to such a structure, the base component can be prevented from hindering the movement of the striker.

In the door lock device for a vehicle of the disclosure, preferably, a cross-sectional shape of a portion of the striker entering the latch groove is an oblong shape when viewed along a rotation axis direction of the latch.

According to such a structure, in addition to the protrusion part, the amount of interference on the striker produced by using the protrusion part can be met by the shape of the striker, and the speed at which the vehicle door is sprung open can be further reduced.

In the door lock device for a vehicle of the disclosure, preferably, a sealing strip is provided around the opening, and when the door closes the opening, the sealing strip is squeezed and deformed by the door.

According to such a structure, sealing can be performed between the vehicle door and the vehicle body. In addition, when the latch is unlocked, the vehicle door can be sprung open by the restoring force of the sealing strip.

### BRIEF DESCRIPTION OF THE DRAWINGS

FIG. 1 is a schematic diagram of a door lock device for a vehicle according to an embodiment of the disclosure, showing a state in which a latch is in an unlocked position.

FIG. 2 is a schematic diagram showing a state in which a latch is in a locked position.

FIG. 3 is a stereoscopic diagram for illustrating a protrusion part.

FIGS. 4A-4C are diagrams for illustrating a process in which a striker is disengaged from a latch groove.

FIGS. 5A-5C are enlarged diagrams for illustrating a protrusion part according to another embodiment.

### SUMMARY

With reference to the accompanying drawings, an embodiment of a door lock device for a vehicle of the disclosure will be described.

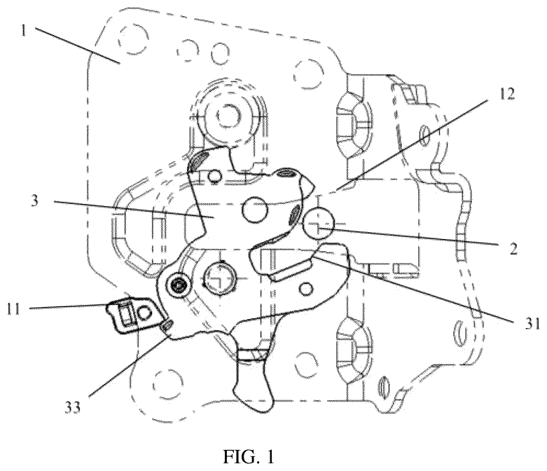

As shown in FIG. 1, the door lock device for a vehicle includes: a base component 1, where the base component 1 is fixed to a vehicle door for opening and closing an opening of a vehicle body; a striker 2, where the striker 2 is fixed to an edge of the opening on the vehicle body; and a latch 3, where the latch 3 is provided on the base component 1 and has a latch groove 31 capable of being engaged with and disengaged from the striker 2. In addition, a base groove 12 for the striker 2 to pass through is also provided on the base component 1.

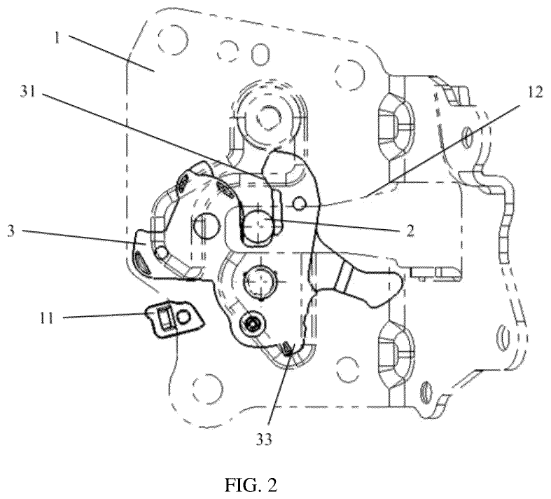

As shown in FIG. 1 and FIG. 2, the latch 3 is capable of rotating between a locking position (the position shown in FIG. 2) in which the striker 2 is constrained by the latch groove 31 and an unlocking position (the position shown in FIG. 1) in which the striker 2 is released. In addition, an abutting part 33 is provided on the latch 3, and an abutted part 11 is provided on the base component 1, and further rotation of the latch 3 when the latch 3 is rotated to the unlocking position is restricted by the abutment between the abutting part 33 and the abutted part 11. The abutted part 11 is made of a material different from that of the base component 1. In this embodiment, the base component 1 is a plastic-coated metal component, and the abutted part 11 is a rubber stopper.

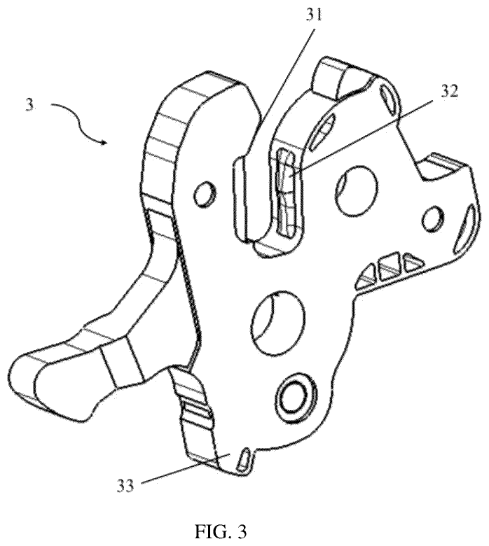

As shown in FIG. 3, in the latch groove 31, a protrusion part 32 protruding toward an inner side of the latch groove 31 is provided within the travel range of the latch, that is, the protrusion part 32 is provided on a surface of the latch groove 31 that contacts the striker 2 when the latch 3 rotates. The protrusion amount of the protrusion part 32 gradually increases and then gradually decreases toward a disengagement direction in which the striker 2 is disengaged from the latch groove 31, that is, a direction from the bottom of the latch groove 31 toward an opening portion. In this embodiment, the protrusion part 32 is formed into an arc shape when viewed along a rotation axis direction of the latch 3. In addition, in this embodiment, the protrusion part 32 is a resin part covering the latch 3.

In addition, the door lock device for a vehicle further has a locking component such as a pawl, which is not shown in the figure. The locking component is arranged on the base component 1 and can move between an allowed position and a locking position. In the allowed position, the locking component is separated from the latch 3 and the latch 3 is allowed to rotate between the locked position and the unlocked position. In the locking position, the locking component abuts against the latch 3 to restrict the rotation of the latch 3 located in the locked position. The function of the locking component is a common function in the art, and the specific structure of the locking component can adopt any common structure in the art.

In this way, when the vehicle door is in an unlocked state, force is applied on the latch 3 by a force applying component, which is not shown in the figure, and the latch 3 is located in the unlocked position. At this time, as shown in FIG. 1, the abutting part 33 abuts against the abutted part 11, and the opening portion of the latch groove 31 faces the striker 2. When the vehicle door is in the fully closed state and the vehicle door is locked, as shown in FIG. 2, the striker 2 enters the latch groove 31 and pushes the latch 3 to rotate to the locked position via the latch groove 31. After the latch 3 rotates to the locked position, the vehicle door is locked by using the striker 2 and the latch 3. In this state, the sealing strip provided at the edge of the opening of the vehicle body is squeezed and deformed by the vehicle door.

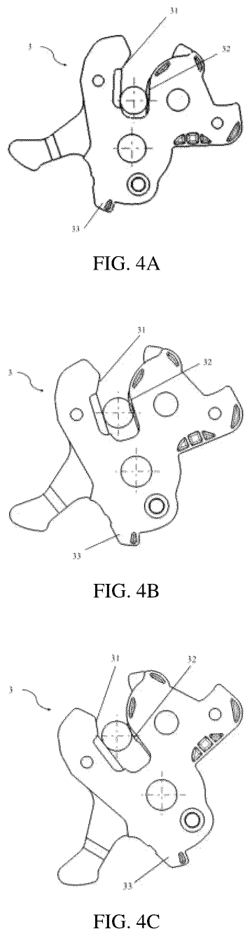

When the vehicle door is unlocked, the vehicle door is sprung open by the restoring force of the squeezed and deformed sealing strip, so that the base component 1 moves with the vehicle door in the direction away from the striker 2. Therefore, as shown in FIGS. 4A-4C, the latch 3 rotates toward the unlocking position because the striker 2 slides closely against the surface provided with the protrusion part 32. After the striker 2 leaves the latch groove 31, the latch 3 continues to rotate through the force-applying member not shown until the abutting part 33 abuts against the abutted part 11.

The effect of this embodiment is described below.

In this embodiment, the protrusion part 32 is provided on the latch groove 31. Therefore, when the vehicle door is sprung open by the sealing strip during unlocking, the striker 2 is disengaged from the latch groove 31 along the protrusion part 32, and the amount of interference of the latch groove 31 on the striker 2 during the disengagement of the striker 2 can be increased. In this way, compared with a case in which the protrusion part 32 is not provided, the speed at which the striker 2 is disengaged can be slowed down, and the speed at which the vehicle door is sprung open due to the restoring force of the sealing strip can be reduced. As a result, the noise during unlocking can be effectively reduced.

In addition, the protrusion amount of the protrusion part 32 gradually increases toward a disengagement direction in which the striker 2 is disengaged from the latch groove 31 and then gradually decreases. Therefore, not only the speed at which the striker 2 is disengaged can be slowed down, and but also the disengagement of the striker 2 cannot be hindered, so that the striker 2 is smoothly disengaged from the latch groove 31. Furthermore, the protrusion part 32 is formed into an arc shape, so that the striker 2 can be moved smoothly to prevent the vehicle door from being stuck when the vehicle door is opened.

In this embodiment, during unlocking, the abutting part 33 of the latch 3 abuts against the abutted part 11 as a rubber stopper, so that the sound produced when the latch 3 abuts against the base component 1 can be reduced, thereby further reducing the noise during unlocking.

### Other Embodiments

The disclosure is not limited to this embodiment, and modifications can be made as follows.

In the above embodiment, the protrusion part 32 is formed into an arc shape when viewed along a rotation axis direction of the latch 3, but the shape of the protrusion part 32 is not limited to thereto. The shape of the protrusion part 32 is not particularly limited, provided that the effective interference on the striker 2 is produced during the process in which the striker 2 is disengaged from the latch groove 31.

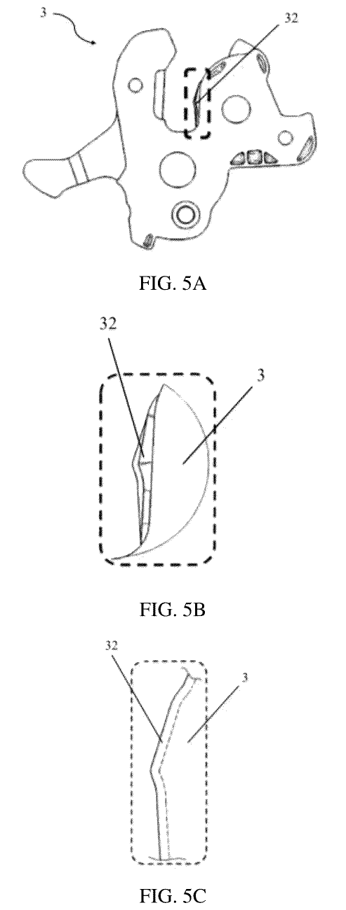

FIGS. 5A-5C are modified examples of such a protrusion part. FIG. 5B is an enlarged view of the dotted frame portion in FIG. 5A. As shown in FIG. 5B, in this modified example, the protrusion part 32 is formed into a roughly triangular shape when viewed along the rotation axis direction of the latch 3. In addition, the protrusion part 32 can also be formed into a trapezoid shape or the like.

In addition, in order to meet the amount of interference on the striker 2 produced by using the protrusion part 32, as shown in FIG. 5C, the shape of the part of the latch 3 covered by the protrusion part 32 can also be changed. Thereby, the protrusion part 32 can be formed more easily.

In the above embodiment, the protrusion part 32 is described as a resin part covering the latch 3, but the formation of the protrusion part 32 is not limited to thereto. The protrusion part 32 can also be formed integrally with the latch 3, or the protrusion part 32 can be formed by other materials.

In the above embodiment, the cross section of a portion of the striker 2 that enters the latch groove 31 is circular when viewed along a rotation axis direction of the latch 3, but the setting of the cross section is not limited to this. In order to meet the amount of interference, the cross section of the striker 2 can be set to be a circle other than a perfect circle such as an oblong circle. In addition, the size of the striker 2 can also be increased.

In the above embodiment, the abutted part 11 is described as a rubber stopper, but the material of the abutted part 11 is not limited thereto. As long as the abutted part 11 is made of a material different from that of the base component 1, for example, the abutted part 11 can be a resin stopper.

The above describes the utility model with reference to a specific example. However, the utility model is not limited to this specific example. A design obtained by the person skilled in the art by applying appropriate design changes to the specific example is also included in the scope of the utility model as long as the design has the characteristics of the utility model.

### REFERENCE SIGNS LIST

1 Base component
11 Abutted portion
2 Striker
3 Latch
31 Latch groove
32 Protrusion part
33 Abutting portion.

1. A door lock device for a vehicle, comprising:
a base component, wherein the base component is fixed to a vehicle door for opening and closing an opening of a vehicle body;
a striker, wherein the striker is fixed to an edge of the opening on the vehicle body; and
a latch, wherein the latch is provided on the base component and has a latch groove capable of being engaged with and disengaged from the striker, and the latch is capable of rotating between a locking position in which the striker is constrained by the latch groove and an unlocking position in which the striker is released, wherein
a protrusion part protruding toward an inner side of the latch groove is provided on a surface of the latch groove that contacts the striker when the latch rotates.

2. The door lock device for a vehicle according to claim 1, wherein
a protrusion amount of the protrusion part gradually increases and then gradually decreases toward a disengagement direction in which the striker is disengaged from the latch groove.

3. The door lock device for a vehicle according to claim 2, wherein
the protrusion part is formed in an arc shape when viewed along a rotation axis direction of the latch.

4. The door lock device for a vehicle according to claim 1, wherein
the protrusion part is a resin part covering the latch.

5. The door lock device for a vehicle according to claim 1, wherein
the latch is provided with an abutting part, and the base component is provided with an abutted part,
further rotation of the latch when the latch is rotated to the unlocking position is restricted by the abutment between the abutting part and the abutted part, and
the abutted part is made of a material different from the base component.

6. The door lock device for a vehicle according to claim 5, wherein
the abutted part is a rubber stopper.

7. The door lock device for a vehicle according to claim 1, wherein
the base component is provided with a base groove for the striker to pass through.

8. The door lock device for a vehicle according to any one of claim 1, wherein
a cross-sectional shape of a portion of the striker entering the latch groove is an oblong shape when viewed along a rotation axis direction of the latch.

9. The door lock device for a vehicle according to any one of claim 1, wherein
a sealing strip is provided around the opening, and
when the vehicle door closes the opening, the sealing strip is squeezed and deformed by the vehicle door.
